(19) United States
(12) Patent Application Publication
(10) Pub. No.: US 2022/0317149 A1
(43) Pub. Date: Oct. 6, 2022

(54) REVERSING ACTUATION TYPE INERTIA DETECTING DEVICE AND SURVEYING INSTRUMENT

(71) Applicant: TOPCON CORPORATION, Tokyo-to (JP)

(72) Inventors: Fumio Ohtomo, Saitama (JP); Satoshi Yanobe, Tokyo-to (JP); Kaoru Kumagai, Tokyo-to (JP); Naoki Shoji, Tokyo-to (JP)

(21) Appl. No.: 17/704,157

(22) Filed: Mar. 25, 2022

(30) Foreign Application Priority Data
Apr. 1, 2021 (JP) 2021-062764

(51) Int. Cl. G01P 15/18; G01P 15/093; G01P 15/08

(52) U.S. Cl. CPC G01P 15/18; G01P 15/093; G01P 15/0802

(57) ABSTRACT

An inner frame is rotatably supported by the outer frame via a first shaft, the inertia detecting unit is rotatably supported by the inner frame via a second shaft orthogonal to the first shaft, a first encoder for detecting a rotation angle between the outer frame and the inner frame, a second encoder for detecting a rotation angle between the inner frame and the inertia detecting unit, and rotation powers are provided on the respective shafts. And the arithmetic processing module is configured to drive the respective rotation powers to make the inertia detecting unit to perform a reversal operation of 180° or one rotation at least once based on outputs from the respective encoders regarding the first shaft and the second shaft and to detect a tilt and a rotation based on detection signals output from the inertia detecting unit before and after the reversal.

### BACKGROUND OF THE INVENTION

The present invention relates to a reversing actuation type inertia detecting device using an inertial sensor and a surveying instrument including the reversing actuation type inertia detecting device.

A surveying instrument is provided with a tilt detecting device for leveling up the instrument or measuring a tilt of the instrument.

As a tilt detecting device which detects a highly accurate horizontality or a small tilt, there are a tilt sensor which uses a tilt of a free liquid surface or a movement of an air bubble sealed in a liquid, or an acceleration sensor which detects a dynamic tilt with the high responsiveness, and the like.

The tilt sensor detects a highly accurate horizontality but has a poor responsiveness, and it has been difficult to use the tilt sensor in a dynamic device. Further, a recent acceleration sensor is constituted of a MEMS (Micro Electro Mechanical System), and the high responsiveness is guaranteed, but a drift due to environmental changes (a temperature, an air pressure, a humidity, and the like) or changes over time has become a problem, and there has been a problem of a lack of the stability.

On the other hand, in recent years, there is also a gyro sensor constituted of the MEMS, and there is a sensor in which a gyro sensor and an acceleration sensor are integrated. Like the acceleration sensor, the gyro sensor for detecting a rotation also has problems of a manufacturing offset and a drift due to environmental changes (a temperature, an air pressure, the humidity, and the like) or to changes over time. As a result, there is a problem of a lack of the stability.

### SUMMARY OF INVENTION

It is an object of the present invention to provide a reversing actuation type inertia detecting device which eliminates offsets or drifts of an inertial sensor such as an acceleration sensor or a gyro sensor and assures the stability, and to provide a surveying instrument including the reversing actuation type inertia detecting device.

To attain the object as described above, a reversing actuation type inertia detecting device according to the present invention includes an outer frame, an inner frame provided inside the outer frame, an inertia detecting unit provided inside the inner frame and having an inertial sensor which detects a tilt and a rotation with respect to the horizontality and an arithmetic processing module, wherein the inner frame is rotatably supported by the outer frame via a first shaft, the inertia detecting unit is rotatably supported by the inner frame via a second shaft orthogonal to the first shaft, a first encoder for detecting a rotation angle between the outer frame and the inner frame is provided on the first shaft, a second encoder for detecting a rotation angle between the inner frame and the inertia detecting unit is provided on the second shaft, rotation powers for rotating respective shafts are provided on the shafts respectively, and wherein the arithmetic processing module is configured to drive and control the respective rotation powers based on detection results from the inertia detecting unit, wherein the arithmetic processing module is configured to drive the respective rotation powers based on a signal issued by the inertia detecting unit corresponding to a tilt with respect to the horizontality, thereby to make the inertia detecting unit horizontal, to make the inertia detecting unit to perform a reversal operation of 180° or one rotation at least once based on outputs from the respective encoders with respect to the first shaft and the second shaft and to detect a tilt and a rotation based on detection signals output from the inertia detecting unit before and after the reversal.

Further, in the reversing actuation type inertia detecting device according to a preferred embodiment, wherein the 180° reversal or rotating operation is repeated at a speed sufficiently higher than an environmental change.

Further, in the reversing actuation type inertia detecting device according to a preferred embodiment, a time measuring means is further comprised, wherein the arithmetic processing module is configured to convert the rotation angles into an angular velocity, based on rotation angles obtained by a first encoder and a second encoder by rotating the inertia detecting unit and a time corresponding to the rotation angle obtained by the time measuring means, and to calibrate rotation detection characteristics of the inertia detecting unit based on the converted angular velocity.

Furthermore, in a surveying instrument according to a preferred embodiment, any reversing actuation type inertia detecting device described above, a distance measuring module for performing the optical wave distance measurement, an optical axis deflector for deflecting a distance measuring optical axis and for sighting a distance measuring light on a measuring point, and a measuring direction detector for detecting a sighting direction of the distance measuring optical axis are comprised.

According to the present invention, there is provided a reversing actuation type inertia detecting device comprising an outer frame, an inner frame provided inside the outer frame, an inertia detecting unit provided inside the inner frame and having an inertial sensor which detects a tilt and a rotation with respect to the horizontality and an arithmetic processing module, wherein the inner frame is rotatably supported by the outer frame via a first shaft, the inertia detecting unit is rotatably supported by the inner frame via a second shaft orthogonal to the first shaft, a first encoder for detecting a rotation angle between the outer frame and the inner frame is provided on the first shaft, a second encoder for detecting a rotation angle between the inner frame and the inertia detecting unit is provided on the second shaft, rotation powers for rotating respective shafts are provided on the shafts respectively, and wherein the arithmetic processing module is configured to drive and control the respective rotation powers based on detection results from the inertia detecting unit, wherein the arithmetic processing module is configured to drive the respective rotation powers based on a signal issued by the inertia detecting unit corresponding to a tilt with respect to the horizontality, thereby to make the inertia detecting unit horizontal, to make the inertia detecting unit to perform a reversal operation of 180° or one rotation at least once based on outputs from the respective encoders with respect to the first shaft and the second shaft and to detect a tilt and a rotation based on detection signals output from the inertia detecting unit before and after the reversal. As a result, it is possible to eliminate an offset and a drift of the inertial sensor and to stably detect a tilt and a rotation.

Furthermore, according to the present invention, there is provided a surveying instrument comprising a reversing actuation type inertia detecting device, a distance measuring module for performing the optical wave distance measurement, an optical axis deflector for deflecting a distance measuring optical axis and for sighting a distance measuring light on a measuring point, a measuring direction detector for detecting a sighting direction of the distance measuring optical axis. As a result, it is possible to highly accurately and stably detect a tilt and a rotation angle of the surveying instrument with respect to the horizontality with the use of the inertial sensor.

### BRIEF DESCRIPTION OF DRAWINGS

FIG. 1 is a schematic plan view showing a reversing actuation type inertia detecting device according to an embodiment of the present invention.

FIG. 2 is a schematic block diagram showing the reversing actuation type inertia detecting device.

FIG. 3 is a schematic diagram of an inertial sensor in the reversing actuation type inertia detecting device.

FIG. 4A, FIG. 4B, FIG. 4C, and FIG. 4D are explanatory drawings showing attitude states of the inertial sensor at the time of the pitching reversal and the rolling reversal.

FIG. 5 is a diagram showing a pitching reversal operation and a rolling reversal operation in a time series.

FIG. 6 is a diagram showing other aspects of the pitching reversal operation and the rolling reversal operation in a time series.

FIG. 7 is a diagram showing still other aspects of the pitching reversal operation and the rolling reversal operation and output states from an acceleration sensor in the still other aspects in time series.

FIG. 8 is a schematic block diagram of a surveying instrument including the reversing actuation type inertia detecting device.

### DETAILED DESCRIPTION OF THE PREFERRED EMBODIMENT

A description will be given below on an embodiment of the present invention by referring to the attached drawings.

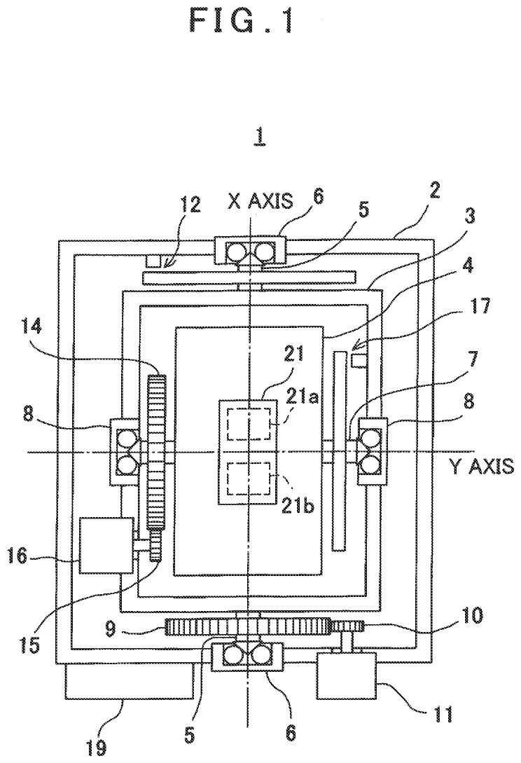

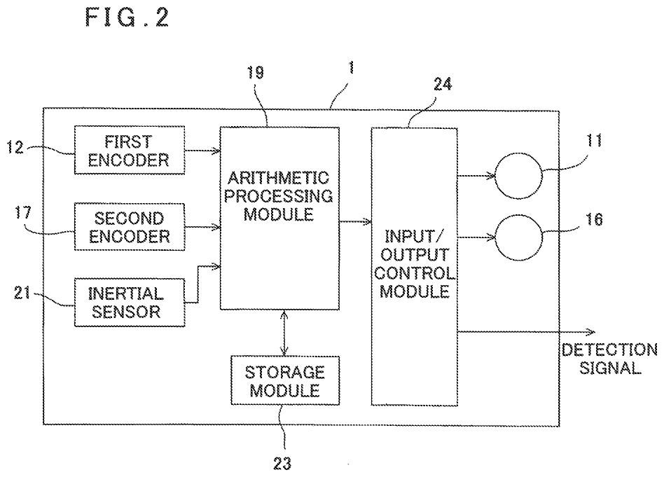

FIG. 1 and FIG. 2 are schematic views of a reversing actuation type inertia detecting device according to an embodiment of the present invention.

FIG. 1 is a schematic plan view showing the reversing actuation type inertia detecting device 1 according to an embodiment of the present invention, and FIG. 2 is a schematic block diagram of the reversing actuation type inertia detecting device 1 according to the embodiment.

An inner frame 3 with a rectangular frame shape is provided inside an outer frame 2 with a rectangular frame shape, an inertia detecting unit 4 is provided inside the inner frame 3, and an inertial sensor 21 is provided in the inertia detecting unit 4.

The inertial sensor 21 is constituted of a triaxial acceleration sensor 21a and a gyro sensor 21b. The acceleration sensor 21a and the gyro sensor 21b may be separately constituted, or an integrated inertial sensor, in which the acceleration sensor 21a and the gyro sensor 21b are integrated, may be provided. Further, in the present embodiment, an integrated inertial sensor constituted of a MEMS is employed.

Further, when the reversing actuation type inertia detecting device 1 is provided in a device (an object device) whose tilt should be detected, the outer frame 2 is mounted to a structural member such as a frame of the object device.

First shafts 5, 5 are protruded from an upper surface and a lower surface of the inner frame 3, and the first shafts 5, 5 are rotatably supported by the outer frame 2 via bearings 6, 6 as provided on the outer frame 2. The first shafts 5, 5 have a first axis, and the inner frame 3 is arranged to be rotatable 360° around the first shafts 5, 5 as a center.

A second shaft 7 is provided to the inertia detecting unit 4, and both end portions of the second shaft 7 are rotatably fitted in bearings 8, 8 as provided in the inner frame 3. The inertia detecting unit 4 is rotatably supported by the inner frame 3 via the second shaft 7. The second shaft 7 has a second axis orthogonal to the first axis, and the inertia detecting unit 4 is arranged to be freely rotatable 360° around the second shaft 7 as a center.

Thus, the inertia detecting unit 4 is rotatably supported in respective two axial directions with respect to the outer frame 2. A mechanism which rotatably supports the inner frame 3 and a mechanism which rotatably supports the inertia detecting unit 4 make up a gimbal mechanism. Thus, since the inertia detecting unit 4 is supported with respect to the outer frame 2 via the gimbal mechanism and there is no mechanism which restricts the rotation of the inner frame 3, the inertia detecting unit 4 is designed so as to be rotatable in all directions with respect to the outer frame 2.

On one of the first shafts 5, 5, e.g., the lower first shaft 5, a first driven gear 9 is fitted, and a first driving gear 10 meshes with the first driven gear 9. Further, a first rotation power (which will be referred to as a first motor 11 hereinafter) is provided on a lower surface of the outer frame 2, and the first driving gear 10 is fitted on an output shaft of the first motor 11.

A first encoder 12 is provided on the other of the first shafts 5, 5, and the first encoder 12 is configured to detect a rotation angle in a lateral direction of the inner frame 3 with respect to the outer frame 2.

A second driven gear 14 is fitted on one end portion of the second shaft 7, and a second driving gear 15 meshes with the second driven gear 14. Further, a second rotation power (which will be referred to as a second motor 16 hereinafter) is provided on a side surface (a left side surface in the drawing) of the inner frame 3, and the second driving gear 15 is fitted on an output shaft of the second motor 16.

A second encoder 17 is provided on the other end portion of the second shaft 7, and the second encoder 17 is configured to detect a rotation angle in a longitudinal direction of the inertia detecting unit 4 with respect to the inner frame 3.

The first encoder 12 and the second encoder 17 are electrically connected to an arithmetic processing module 19.

The inertial sensor 21 is electrically connected to the arithmetic processing module 19, and a signal from the inertial sensor 21 is input to the arithmetic processing module 19.

An accelerator sensor 21a of the inertial sensor 21 is configured to detect accelerations of horizontal two axes (X axis, Y axis) orthogonal to each other and an acceleration of one axis (Z axis) in a vertical direction orthogonal to the horizontal two axes (perpendicular to a page space), which are the accelerations in three directions in total. Further, a gyro sensor 21b of the inertial sensor 21 is configured to detect rotations with respect to the horizontal two axes and a rotation with respect to a vertical axis orthogonal to the horizontal two axes (perpendicular to a page space). Here, the horizontal two axes are the first shaft 5 and the second shaft 7 in FIG. 1, the rotation (a tilt) around the first shaft 5 is defined as the pitching, the rotation (a tilt) around the second shaft 7 is defined as the rolling, and the rotation around an axis in the vertical direction is defined as the yawing.

A further description will be given on the reversing actuation type inertia detecting device 1 by referring to FIG. 2.

The reversing actuation type inertia detecting device 1 includes a storage module 23 and an input/output control module 24 besides the first encoder 12, the second encoder 17, the inertial sensor 21, the arithmetic processing module 19, the first motor 11 and the second motor 16.

As the arithmetic control module 19, a CPU specialized to the present embodiment, a general-purpose CPU, an embedded CPU, or the like is used, and the arithmetic processing module 19 has a time measuring means such as a clock generator incorporated therein. Further, as the storage module 23, a semiconductor memory such as a RAM or a ROM is used.

In the storage module 23, various types of programs are stored. These programs include: an arithmetic program for detecting a tilt of the inertia detecting unit 4 with respect to the outer frame 2, a program for eliminating offsets or drifts of the inertial sensor 21 and a program for driving and controlling the first motor 11 and the second motor 16, and also the data, for instance, the arithmetic data (i.e., the detected tilt angle data, the angular velocity data, and the rotation angle data) or the like.

The input/output control module 24 drives the first motor 11 and the second motor 16 based on a control command output from the arithmetic processing module 19, and outputs tilt angle data and data concerning the rotation calculated by the arithmetic processing module 19 as detection signals.

The inertial sensor 21 detects tilts and tilt directions with respect to horizontal two axes, rotations with respect to the horizontal two axes, and a rotation (a horizontal rotation) with respect to the vertical axis. Here, a mechanical pitching with respect to structural members of the object device corresponds to a rotating direction (a tilt direction) as detected by the first encoder 12 and a mechanical rolling corresponds to a rotating direction (a tilt direction) detected by the second encoder 17, respectively, and the mechanical pitching and rolling have to match the pitching and the rolling as detected by the inertial sensor 21 in a case where the object device is stationary. This match is a useful match condition when performing the sensitivity calibration of the inertial sensor 21.

The arithmetic processing module 19 calculates a tilt angle and a tilt direction based on a detection result from the inertial sensor 21, and calculates a rotation angle of the first encoder 12 and a rotation angle of the second encoder 17 corresponding to the tilt angle and the tilt direction.

It is to be noted that the outer frame 2 and the inertial sensor 21 are mechanically linked by an output of the first encoder 12 and an output of the second encoder 17, and are set in such a manner that a rotation angle from a predetermined reference angle (e.g., 0° rotation angle) is indicated.

A description will be given below on an operation of the reversing actuation type inertia detecting device 1.

When the reversing actuation type inertia detecting device 1 (the outer frame 2) tilts with respect to the horizontality, the inertial sensor 21 outputs a signal corresponding to the tilt.

The arithmetic processing module 19 calculates a tilt angle and a tilt direction based on a signal from the inertial sensor 21 (a signal from the acceleration sensor 21a), further calculates rotation amounts of the first motor 11 and the second motor 16 in order to make the tilt angle and the tilt direction to 0 based on the calculation results, and issues a driving command for rotating the first motor 11 and the second motor 16 respectively by the calculated rotation amounts via the input/output control module 24.

The first motor 11 and the second motor 16 are driven such that the inertial sensor 21 tilts in opposite directions of the calculated tilt angle and tilt direction by driving the first motor 11 and the second motor 16. Driving amounts (rotation angles) of the motors are detected by the first encoder 12 and the second encoder 17, and the drivings of the first motor 11 and the second motor 16 are stopped when rotation angles become the calculated results.

Further, the rotations of the first motor 11 and the second motor 16 are finely adjusted such that the inertial sensor 21 detects the horizontality.

In this state where the outer frame 2 tilts, the inertia detecting unit 4 is controlled horizontally, and the arithmetic processing module 19 calculates a tilt angle of the object device from the horizontality based on an output the first encoder 12 and an output of the second encoder 17. Further, angular velocities of the pitching, the rolling and the yawing based on a signal from the inertial sensor 21 (a signal from the gyro sensor 21b) are calculated (integrated) and converted into respective rotation angles.

The arithmetic processing module 19 outputs, the tilt angle and respective rotation angles of the pitching, the rolling, and the yawing to the outside as calculated based on the rotation angles detected by the first encoder 12 and the second encoder 17 as detection signals (the tilt angle data) of the reversing actuation type inertia detecting device 1.

Further, when a detection signal of the inertial sensor 21 is fed back to the arithmetic processing module 19 in real time and the first motor 11 and the second motor 16 are controlled in such a manner that the horizontality of the inertial sensor 21 is maintained, a dynamic change in tilt of the outer frame 2 can be detected in real time.

Meanwhile, the inertial sensor 21 is subject to manufacturing offsets and drifts due to environmental changes (a temperature, an air pressure, the humidity, and the like) or changes over time.

A description will be given below on the elimination of offsets and drifts of the reversing actuation type inertia detecting device 1 in the present embodiment.

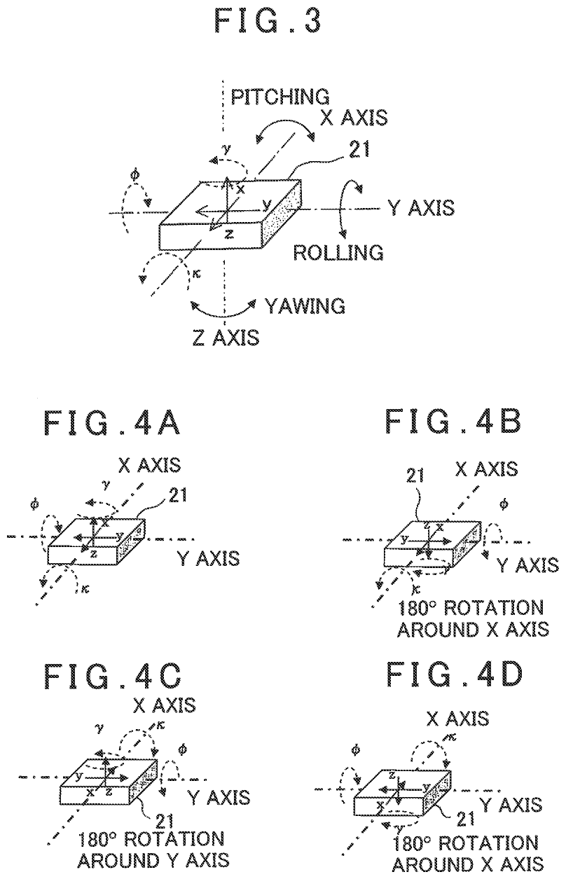

FIG. 3 is a diagram provided by extracting and schematizing the inertial sensor 21 in FIG. 1.

In FIG. 3, and X axis corresponds to the first axis 5, Y axis corresponds to the second axis 7 and an axis perpendicular to a plane including X axis and Y axis is Z axis. Further, the rotation around X axis is the pitching, the rotation around Y axis is the rolling and the rotation around Z axis is the yawing.

Further, arrows of x, y, z shown in the inertial sensor 21 indicate acceleration directions of the acceleration sensor 21a included in the inertial sensor 21, and x, y, z coincide with the X axis, the Y axis, and the Z axis, respectively. The acceleration sensor 21a outputs acceleration signals of x, y, z corresponding to the three axes. Further, arrows of ϕ, κ, γ indicate rotating directions detected by the gyro sensor 21b included in the inertial sensor 21, and the gyro sensor 21b outputs angular velocity signals of the pitching (4), the rolling (K), and the yawing (γ).

In the present embodiment, since the motors and the encoders are coupled in the X axis and the Y axis respectively, the inertia detecting unit 4 can be forcibly and accurately reversed 180° or continuously rotated with respect to the X axis and the Y axis. Further, the reversal and the rotation are set to a speed sufficiently higher than environmental changes so as not to be affected by the environmental changes.

FIG. 4A, FIG. 4B, FIG. 4C and FIG. 4D show attitude states of the inertial sensor 21 with respect to the object device.

FIG. 4A shows a state at the time of starting an operation, and at that time, outputs from the first encoder 12 and the second encoder 17 (a rotation angle around the X axis, a rotation angle around the Y axis), and outputs from the inertial sensor 21 (the acceleration sensor 21a: x, y, z, the gyro sensor 21b: ϕ, κ, γ) are measured.

Then, in performing the pitching reversal of 180° around the X axis (FIG. 4B) and further in performing the rolling reversal of 180° around the Y axis (FIG. 4C), the front and rear and the left and right of the inertia detecting unit 4 are reversed. Then, in performing the pitching reversal of 180° around the X axis (FIG. 4D) and further in performing the rolling reversal of 180° around the Y axis restores an original attitude state (an attitude state at the time of starting the operation) (FIG. 4A).

FIG. 4C shows an attitude state reversed in the two axes (the X axis, the Y axis) from the attitude state in FIG. 4A.

When the two-axis reversal operation has been performed and a difference of outputs of the acceleration sensor 21a of the inertial sensor 21 is taken between before and after the two-axis reversal operation, an offset and a long-term drift component of the acceleration sensor 21a are removed, and a doubled tilt angle difference is obtained due to the output difference of the acceleration sensor 21a.

Alternatively, by repeatedly controlling the pitching and rolling reversals such that a difference between outputs from the acceleration sensor 21a in the reversal operations in the attitude state (A) and the attitude state (C) becomes 0, it is possible to make the inertia detecting unit 4 horizontal. It is to be noted that an average value before and after the two-axis reversal operation means an offset and a long-term drift component.

Further, by taking a difference in ϕ, γ of the gyro sensor 21b of the inertial sensor 21 between before and after the reversal operation in the reversal operation from the attitude state (A) to the attitude state (B), a difference in κ, γ of the gyro sensor 21b between before and after the reversal operation in the reversal operation from the attitude state (B) to the attitude state (C), a difference in ϕ, γ of the gyro sensor 21b between before and after the reversal operation in the reversal operation from the attitude state (C) to the attitude state (D), and a difference κ, γ of the gyro sensor 21b between before and after the reversal operation in the reversal operation from the attitude state (D) to the attitude state (A), it is possible to remove an offset and a long-term drift component of each of ϕ, κ, γ of the gyro sensor 21b and to obtain a doubled angular velocity. It is to be noted that an average value before and after the reversal operation means the offset and the long-term drift component.

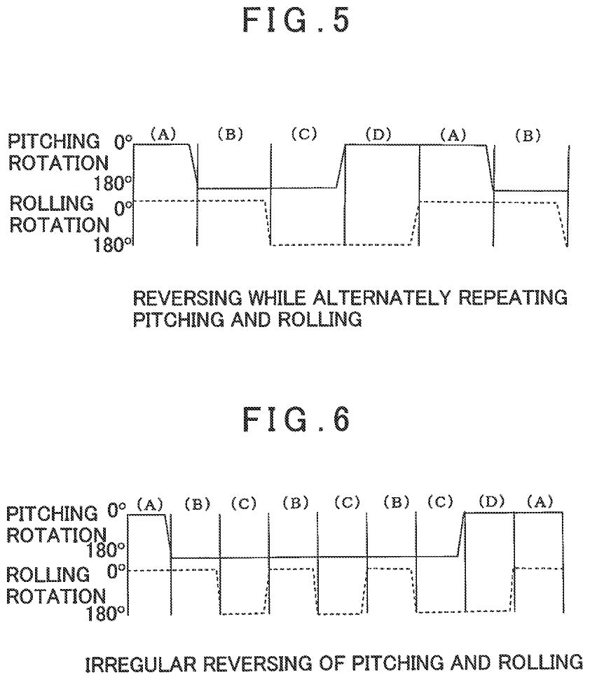

FIG. 5 shows the pitching and rolling reversal operations shown in FIG. 4 in time series, where the pitching reversal operation and the rolling reversal operation are alternately repeated. FIG. 5 shows that (A), (B), (C), and (D) correspond to the attitude states shown in FIG. 4A, FIG. 4B, FIG. 4C, and FIG. 4D, respectively.

The pitching and rolling reversal operations are not restricted to alternate reversals. For example, as shown in FIG. 6, a plurality of rolling reversal operations may be performed every one pitching reversal operation.

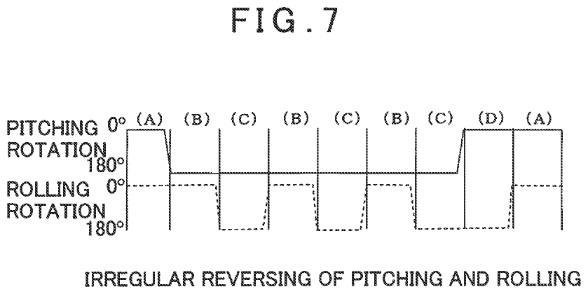

The reversal operation is not limited to a switching reversal operation (a switching reversal operation, i.e., a reversal by the intermittent rotation), and as shown in FIG. 7, one axis may be for the switching reversal operation and the other axis may be for a reversal operation of the continuous rotation (a continuous rotating operation).

FIG. 7 is a graph showing the rotating operation of the inertia detecting unit 4 in time series, and shows a case where, regarding the pitching rotation, the switching reversal operation (0° or 180°) is repeated. It shows a case where, regarding the rolling rotation, the rolling rotation is a continuous rotating operation (0° to 360° (0°) to 360° (0°) to 360° . . . ), and a case where a plurality of rolling rotations are performed with respect to one pitching rotation.

In FIG. 7, the switching reversal operation is repeated for the pitching, and the inertial sensor 21 is controlled horizontally in the pitching rotating direction based on an output y of the acceleration sensor 21a as obtained by this reversal operation.

For the rolling, the continuous rotating operation of the rolling is performed, and by this continuous rotating operation, the acceleration sensor 21a produces a waveform of a sinusoidal wave as an output x. A position, where the output x of the accelerometer 21a is zero, indicates a horizontal state of rolling, and an attitude state of the inertial sensor 21 at this time is either (A), (B), (C), or (D) in FIG. 7. For example, the attitude state (A) is a pitching rotation angle 0° and a rolling rotation angle 0°.

Further, as shown in FIG. 7, a sinusoidal wave of the output x of the acceleration sensor 21a reverses with the pitching reversal operation.

Since the gyro sensor 21b's κ and γ are interchanged with respect to a horizontal plane due to the continuous rotating operation of the rolling, the arithmetic processing module 19 time-integrates a gyro angular velocity γ at the time of the horizontality based on the horizontal detection by the acceleration sensor 21a and calculates an angular change in yawing (a horizontal rotation angle). Alternatively, the arithmetic processing module 19 calculates a tilt with respect to the horizontality by the rolling rotation angle, calculates a horizontal angular velocity by a composite calculation (e.g., a composite ratio) of the gyro's angular velocity κ and angular velocity γ corresponding to the tilt, and calculates a horizontal rotation angle by integrating over time.

An angle change of the yawing (a horizontal rotation angle change) can be obtained by time-integrating the angular velocity γ of the gyro sensor 21b at the time of the horizontality. In this case, by taking a difference based on a reversal state of the attitude, it is possible to obtain the angle change by time-integrating based on a doubled angular velocity in which an offset and a long-term drift component are removed. It is to be noted that the detection of the rolling reversal state is performed in synchronization with the second encoder 17.

Further, although not shown, both the pitching and the rolling are subjected to the continuous rotating operation, a horizontal state may be detected by outputs x, y, z of the acceleration sensor 21a, and a change of horizontal rotation angle may be obtained at the time of the horizontality. Alternatively, a tilt with respect to the horizontality is calculated by the pitching and rolling rotation angles, and the horizontal rotation may be obtained by a composite calculation (e.g., a composite ratio) of outputs ϕ, κ, γ of the gyro sensor 21b corresponding to the tilt. As regards the numbers of pitching and rolling rotations at this time, it is desirable to increase a rotation ratio severalfold or more for the identification of the rotations. In this case, likewise, by taking a difference based on the attitude reversal state, it is possible to eliminate an offset and a long-term drift component and to obtain a doubled angular velocity.

Meanwhile, the accuracy and the stability of sensitivity characteristics of ϕ, κ, γ of the gyro sensors 21b become problems in the high-precision measurement. In the present embodiment, the sensitivity characteristics of ϕ, κ, γ of the gyro sensors 21b can be also calibrated.

The inertial sensor 21 is rotated at a constant or substantially constant speed by the first motor 11 and the second motor 16, rotation angles of the respective motors are detected by the first encoder 12 and the second encoder 17 respectively and converted into angular velocities by a time measuring means as incorporated in the arithmetic processing module 19. By comparing the converted angular velocities with corresponding ϕ, κ, or γ of the gyro, it is possible to calibrate the sensitivity characteristics.

A description will be given on an example of calibrating the sensitivity characteristics. The first motor 11 and the second motor 16 are rotated at a constant or substantially constant speed, rotation angles of the first encoder 12 and the second encoder 17 are detected with the time measurement, and accurate angular velocities are obtained.

At this time, the rolling rotation (the rotation around the Y axis by the second motor 16) is rotated sufficiently fast as compared to the pitching rotation (the rotation around the X axis by the first motor 11).

Here, by comparing an angular velocity of the rolling (the rotation around the Y axis) by the second encoder 17 with an output ϕ of the gyro sensor 21b, it is possible to perform the sensitivity calibration.

Further, outputs κ, γ of the gyro sensor 21b become two sinusoidal signals with a 90° phase according to the rolling (the rotation around the Y axis). A maximum value and a minimum value of these two signals are angular velocities of the pitching (the rotation around the X axis by the first motor 11), and the maximum value is indicated when a detection plane of the gyro sensor 21b (κ, γ) directly faces the rotation plane around the X axis, whilst the minimum value is indicated when it is opposite. Therefore, by comparing with the outputs κ, γ of the gyro sensor 21b, it is possible to perform the sensitivity calibration.

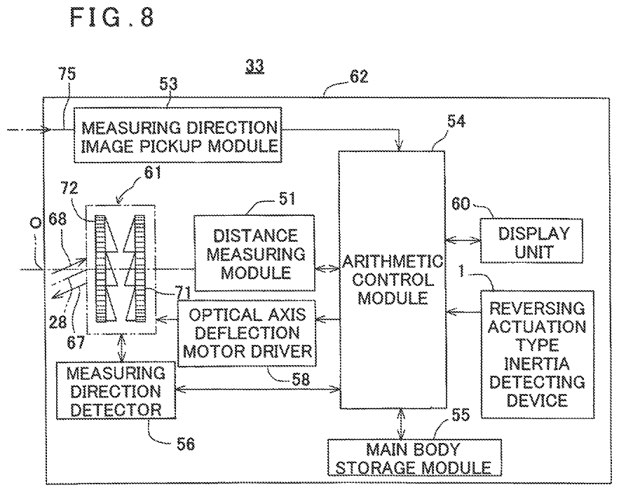

Next, a description will be given on a surveying instrument 33 including the reversing actuation type inertia detecting device 1 by referring to FIG. 8. The surveying instrument 33 is adapted to mount on a tripod, a transfer car, or even a flying vehicle, corresponding to use.

The surveying instrument 33 mainly includes a distance measuring module 51, a measuring direction image pickup module 53, the arithmetic control module 54, a main body storage module 55, the reversing actuation type inertia detecting device 1, a measuring direction detector 56, an optical axis deflection motor driver 58, a display unit 60 and an optical axis deflector 61. They are accommodated in a casing 62 and integrated.

Further, the outer frame 2 of the reversing actuation type inertia detecting device 1 is fixed to the casing 62 or fixed to a structural member fixed to the casing 62, and it is integrated with the casing 62, i.e., the surveying instrument 33.

As the arithmetic control module 54, a CPU specialized to the present embodiment, a general-purpose CPU, an embedded CPU, or the like is used. Further, as the main body storage module 55, a semiconductor memory such as a RAM or a ROM, a magnetic recording memory such as an HDD, or an optical recording memory is used. Further, some of the functions of the arithmetic control module 54 may be allocated as the arithmetic processing module 19.

In the main body storage module 55, various types of programs for carrying out this embodiment are stored. These programs include a distance measurement program, a tracking program, an image processing program, an optical axis deflection control program, and a program for performing the calibration of the reversing actuation type inertia detecting device 1. The arithmetic control module 54 develops and executes the stored programs. Further, the various kinds of data, e.g., the measurement data and the image data are stored in the main body storage module 55.

The arithmetic control module 54 controls the optical axis deflector 61 via the optical axis deflection motor driver 58. Further, the arithmetic control module 54 controls the deflection of the distance measuring optical axis 28 via the optical axis deflector 61, and performs the synchronous control of the distance measuring module 51 and the measuring direction image pickup module 53.

The reversing actuation type inertia detecting device 1 detects rotation angles provided by the first encoder 12 and the second encoder 17 and detects an acceleration and angular velocities provided by the inertial sensor 21 when the inertia detecting unit 4 is controlled horizontally or the horizontality of the inertia detecting unit 4 is detected, and the detection results are input to the arithmetic control module 54. The arithmetic control module 54 obtains an inclination angle (a vertical angle) with respect to the horizontality of the surveying instrument 33 and a horizontal rotation angle based on the detection results.

The optical axis deflector 61 is arranged on the distance measuring optical axis 28. A straight optical axis transmitted through the center of the optical axis deflector 61 is a reference optical axis O. The reference optical axis O coincides with the distance measuring optical axis 28 when not deflected by the optical axis deflector 61, and has a predetermined relationship with the casing 62.

It is to be noted that, as the optical axis deflector 61, one disclosed in Japanese Patent Application Publication No. 2016-151423, Japanese Patent Application Publication No. 2017-90244, or Japanese Patent Application Publication No. 2017-106813 can be used.

A brief description will be given below on the optical axis deflector 61.

The optical axis deflector 61 includes a pair of disk prisms 71, 72 constituted of the optical prisms. The disk prisms 71, 72 have discoid shapes with the same diameter (or polygonal shapes circumscribing a circle). The disk prisms 71, 72 are arranged concentrically on and orthogonally to the distance measuring optical axis 28, and further are arranged in parallel at a predetermined interval. The disk prisms 71, 72 are provided rotatably around the reference optical axis O respectively, and the disk prisms 71, 72 are configured in such a manner that the disk prisms 71, 72 are separately and independently rotated by motors. The motors are driven by the optical axis deflection motor driver 58, and the arithmetic control module 54 is configured to control rotation angles, rotating directions, rotation speeds, and the like of the disk prisms 71, 72 via the optical axis deflection motor driver 58. Thus, by controlling the rotations of the disk prisms 71, 72, it is possible to deflect the distance measuring optical axis 28 at an arbitrary angle from 0° to a maximum deflection angle (e.g., ±30°) with reference to the reference optical axis O.

The distance measuring module 51 has a function as an electronic distance meter, projects the distance measuring light 67 to a measuring point or an object, receives the reflected distance measuring light 68 from the measuring point or the object, and performs an electronic distance measurement based on a reciprocating time of a distance measuring light.

Further, the optical axis deflector 61 deflects the distance measuring optical axis 28, and thereby a sighting on the measuring point and a change of the measuring point are carried out.

The deflecting of the distance measuring optical axis 28 by the optical axis deflector 61 enables the measurement in a change range of the optical axis deflector 61 with the reference optical axis O fixed (i.e., with the surveying instrument 33 fixed).

Further, when the disk prisms 71, 72 are continuously driven and continuously deflected while continuously irradiating the distance measuring light 67, it is possible to two-dimensionally scan the distance measuring light 67 with a predetermined pattern. Further, by pulse-emitting the distance measuring light 67 and by carrying out the distance measurement for each pulsed light, it is possible to acquire the point cloud data along a scan locus.

The measuring direction detector 56 detects the respective rotation angles of the disk prisms 71, 72, and detects a measuring direction (a sighting direction) of the distance measuring optical axis 28, i.e., a deflection angle and a deflecting direction of the distance measuring optical axis 28 with respect to the reference optical axis O in real time. Therefore, it is possible to detect an angle and a direction (to measure angle) of the distance measuring optical axis 28 with respect to the reference optical axis O at the distance measurement.

A measuring direction detecting result (an angle measurement result) is associated with a distance measurement result and input to the arithmetic control module 54, and the arithmetic control module 54 associates the distance measurement result with an angle measurement result and stores them in the main body storage module 55.

The measuring direction image pickup module 53 has a known relationship with the reference optical axis O, that is, an image pickup optical axis 75 of the measuring direction image pickup module 53 is parallel with the reference optical axis O, and a distance between the optical axes is known. Further, the measuring direction image pickup module 53 is a camera with a field angle larger than a maximum deflection angle (e.g., ±30°) of the optical axis deflector 61, and acquires the image data including a maximum deflection range of the optical axis deflector 61. Further, the measuring direction image pickup module 53 is capable of acquiring moving images or continuous images.

An image pickup element of the measuring direction image pickup module 53 is a CCD or a CMOS sensor which is an aggregation of pixels, and is configured such that a position of each pixel can be specified on an image element. For instance, each pixel has pixel coordinates in a coordinate system having the image pickup optical axis 75 as an origin, and the position on the image element is specified by the pixel coordinates.

The display unit 60 displays an image acquired by the measuring direction image pickup module 53, and displays a measurement state, a measurement result, and the like. It is to be noted that the display unit 60 may be designed as a touch panel and may be used simultaneously as an operation module.

In the embodiment of the surveying instrument 33 described above, a tilt with respect to the horizontality and a horizontal rotation angle are acquired from detection results of the reversing actuation type inertia detecting device 1, and a distance is acquired from distance measurement results of the distance measuring module 51. On the other hand, regarding the positional information of the surveying instrument 33, a GNSS may be provided on the surveying instrument 33, and the positional information from the GNSS may be combined with a tilt and the horizontal rotation of the instrument provided by the reversing actuation type inertia detecting device 1.

1. A reversing actuation type inertia detecting device comprising: an outer frame, an inner frame provided inside said outer frame, an inertia detecting unit provided inside said inner frame and having an inertial sensor which detects a tilt and a rotation with respect to the horizontality and an arithmetic processing module, wherein said inner frame is rotatably supported by said outer frame via a first shaft, said inertia detecting unit is rotatably supported by said inner frame via a second shaft orthogonal to said first shaft, a first encoder for detecting a rotation angle between said outer frame and said inner frame is provided on said first shaft, a second encoder for detecting a rotation angle between said inner frame and said inertia detecting unit is provided on said second shaft, rotation powers for rotating respective shafts are provided on said shafts respectively, and wherein said arithmetic processing module is configured to drive and control said respective rotation powers based on detection results from said inertia detecting unit, wherein said arithmetic processing module is configured to drive said respective rotation powers based on a signal issued by said inertia detecting unit corresponding to a tilt with respect to the horizontality, thereby to make said inertia detecting unit horizontal, to make said inertia detecting unit to perform a reversal operation of 180° or one rotation at least once based on outputs from said respective encoders with respect to said first shaft and said second shaft and to detect a tilt and a rotation based on detection signals output from said inertia detecting unit before and after the reversal.

2. The reversing actuation type inertia detecting device according to claim 1, wherein said 180° reversal or rotating operation is repeated at a speed sufficiently higher than an environmental change.

3. The reversing actuation type inertia detecting device according to claim 1, further comprising a time measuring means, wherein said arithmetic processing module is configured to convert said rotation angles into an angular velocity, based on rotation angles obtained by a first encoder and a second encoder by rotating said inertia detecting unit and a time corresponding to said rotation angle obtained by said time measuring means, and to calibrate rotation detection characteristics of said inertia detecting unit based on said converted angular velocity.

4. A surveying instrument comprising a reversing actuation type inertia detecting device according to claim 1, a distance measuring module for performing the optical wave distance measurement, an optical axis deflector for deflecting a distance measuring optical axis and for sighting a distance measuring light on a measuring point, and a measuring direction detector for detecting a sighting direction of said distance measuring optical axis.

5. A surveying instrument comprising a reversing actuation type inertia detecting device according to claim 2, a distance measuring module for performing the optical wave distance measurement, an optical axis deflector for deflecting a distance measuring optical axis and for sighting a distance measuring light on a measuring point, and a measuring direction detector for detecting a sighting direction of said distance measuring optical axis.

6. A surveying instrument comprising a reversing actuation type inertia detecting device according to claim 3, a distance measuring module for performing the optical wave distance measurement, an optical axis deflector for deflecting a distance measuring optical axis and for sighting a distance measuring light on a measuring point, and a measuring direction detector for detecting a sighting direction of said distance measuring optical axis.
